(19) United States
(12) Patent Application Publication
(10) Pub. No.: US 2012/0044532 A1
(43) Pub. Date: Feb. 23, 2012

(54) MANAGEMENT DEVICE, FILE SERVER SYSTEM, EXECUTION METHOD AND MANAGEMENT PROGRAM

(75) Inventor: Kouitirou TAKAHASI, Kawasaki (JP)

(73) Assignee: Fujitsu Limited, Kawasaki (JP)

(21) Appl. No.: 13/207,527

(22) Filed: Aug. 11, 2011

(30) Foreign Application Priority Data
Aug. 17, 2010 (JP) 2010-182419

(51) Int. Cl. G06F 3/12

(52) U.S. Cl. 358/1.15

(57) ABSTRACT

A file server system including: a plurality of calculation nodes configured to execute jobs by using files; a primary file server configured to store the files related to the jobs; a plurality of secondary file servers configured to store a part of the files of the primary file server; a load state management unit configured to manage load states of the secondary file servers; a selector configured to select a secondary file server that is in a state of the lowest load among the secondary file servers, when the jobs to be executed are assigned; and an assignment management unit configured to assign the jobs to be executed to the secondary file server selected by the selecting unit.

### CROSS-REFERENCE TO RELATED APPLICATION

This application is based upon and claims the benefit of priority of the prior Japanese Patent Application No. 2010-182419, filed on Aug. 17, 2010, the entire contents of which are incorporated herein by reference.

### FIELD

The present invention relates to a management device, a file server system, an execution method and a management program.

### BACKGROUND

Traditionally, a method for assigning jobs to multiple computers connected to a network and executing the jobs in a computer system is known (for example, refer to Japanese Laid-open Patent Publication No. 6-332782). FIG. 10 is a diagram schematically illustrating a network configuration of a conventional computer system. The conventional computer system 500 illustrated in FIG. 10 includes a plurality of calculation nodes 501, a management server 502, a common file server 503, a public line network 504, and client computers 505.

The common file server 503 is connected to the plurality of calculation nodes 501 so that the communication file 503 can communicate with the plurality of calculation nodes 501. The calculation nodes 501 are each connected to the management server 502 so that the calculation nodes 501 can communicate with the management server 502. The management server 502 is connected to the client computers 505 through the public line network 504 so that the management server 502 can communicate with the client computers 505.

The client computers 505 are information processing terminal devices that are each used by a user. The user enters a calculation instruction through any of the client computers 505, for example.

The management server 502 controls the calculation nodes 501 on the basis of the calculation instruction received from the client computer 505 or the like so that the calculation nodes 501 execute jobs. Specifically, the management server 502 assigns the jobs to the calculation nodes 501 and causes the calculation nodes 501 to execute the jobs.

The calculation nodes 501 execute the jobs assigned by the management server 502. The calculation nodes 501 each acquire, from the common file server 503, data that is necessary to execute the jobs. Then, the calculation nodes 501 cause the results of calculations to be stored in the common file server 503.

The common file server 503 is a server that stores and manages input and output files for the jobs assigned to the calculation nodes 501. The common file server 503 provides, to the calculation nodes 501 in response to requests or the like from the calculation nodes 501, data that is necessary for the jobs. The common file server 503 stores the results of the calculations performed by the calculation nodes 501. Specifically, the common file server 503 centrally manages the data that is used by the calculation nodes 501 to execute the jobs.

Since the common file server 503 stores the input and output files for the jobs assigned to the calculation nodes 501, it is not necessary to assign a specific job to a specific calculation node 501 and it is possible to flexibly assign jobs to the calculation nodes 501.

However, in the conventional computer system 500, when a large number of calculation nodes 501 are connected to the common file server 503, access that exceeds the throughput of the common file server 503 may be performed, and the common file server 503 may be excessively loaded and may affect execution of jobs.

### SUMMARY

According to an aspect of the embodiments, a file server system including: a plurality of calculation nodes configured to execute jobs by using files; a primary file server configured to store the files related to the jobs; a plurality of secondary file servers configured to store a part of the files of the primary file server; a load state management unit configured to manage load states of the secondary file servers; a selector configured to select a secondary file server that is in a state of the lowest load among the secondary file servers, when the jobs to be executed are assigned; and an assignment management unit configured to assign the jobs to be executed to the secondary file server selected by the selecting unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating the configuration of a file server system according to an example of a first embodiment.

FIG. 2 is a diagram illustrating an example of a job assignment table included in the file server system according to the example of the first embodiment.

FIG. 3 is a diagram schematically illustrating the configuration of a file server system according to an example of a second embodiment.

FIG. 4 is a diagram illustrating an example of a data transfer amount table included in the file server system according to the example of the second embodiment.

FIG. 5 is a diagram schematically illustrating the configuration of a file server system according to an example of a third embodiment.

FIG. 6 is a flowchart of a process of assigning a job to a secondary file server in the file server system according to the example of the third embodiment.

FIG. 7 is a diagram illustrating an example of a job transfer amount recording table that is used in a first modified example.

FIG. 8 is a flowchart of a process of determining whether or not the secondary file server needs to be used in a file server system according to the first modified example.

FIG. 9 is a flowchart of a process of determining whether or not the secondary file server needs to be used in a file server system according to a second modified example.

FIG. 10 is a diagram schematically illustrating the configuration of a conventional computer system.

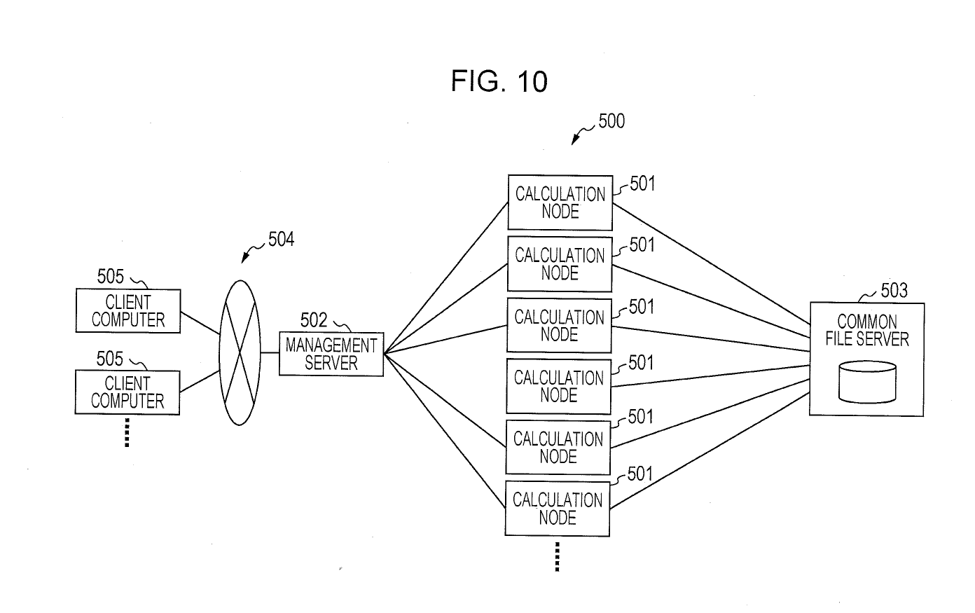

### DESCRIPTION OF EMBODIMENTS

Embodiments of a file server system disclosed herein are described below with reference to the accompanying drawings.

### (A) First Embodiment

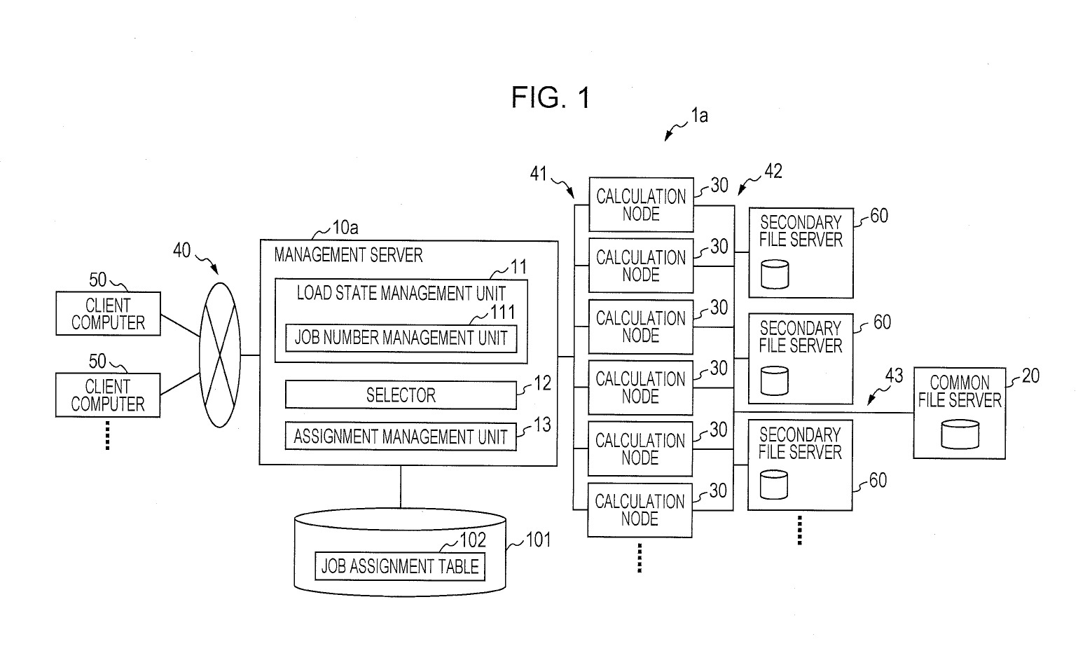

FIG. 1 is a diagram schematically illustrating the configuration of a file server system 1a according to an example of a first embodiment.

The file server system 1a is a distributed processing system that distributes jobs related to a calculation instruction to a plurality of calculation nodes 30 and causes the plurality of calculation nodes 30 to execute the jobs. As illustrated in FIG. 1, the file server system 1a includes the calculation nodes 30, secondary file servers 60, client computers 50, a management server 10a and a common file server 20.

The plurality of client computers 50 (two or more client computers in the example illustrated in FIG. 1) are connected to the management server 10a through a network 40 so that the client computers 50 can communicate with the management server 10a. The management server 10a is connected to the plurality of calculation nodes 30 in parallel through a network 41 so that the management server 10a can communicate with the calculation nodes 30. The calculation nodes 30 are connected to the secondary file servers 60 through a network 42 so that the calculation nodes 30 can communicate with the secondary file servers 60. In addition, the calculation nodes 30 are connected to the common file server 20 through a network 43 so that the calculation nodes 30 can communicate with the common file server 20.

The networks 40, 41, 42 and 43 are communication networks such as the Internet or public line networks. For example, the networks 40, 41, 42 and 43 achieve transmission and reception of data in accordance with a standard such as Ethernet (registered trademark).

The client computers 50 are information processing devices that each receive various instructions entered by a user and various types of data entered by the user. The user uses at least one of the client computers 50 to enter a calculation instruction. The client computer 50 transmits the entered calculation instruction to the management server 10a through the network 40.

The client computers 50 each have a general computer hardware configuration and include a central processing unit (CPU), a random access memory (RAM), a read only memory (ROM), a storage device and a network device. In the present embodiment, a detailed description of the hardware configurations of the client computers 50 is omitted for convenience.

In the example illustrated in FIG. 1, the number of the client computers 50 is two. However, the number of the client computers 50 is not limited to two. The number of the client computers 50 may be changed when necessary.

The client computers 50 each achieve the aforementioned functions by causing the CPU to execute an operating system (OS) and various applications.

The calculation nodes 30 are information processing devices that are each capable of performing various types of calculations. The file server system 1a includes the plurality of calculation nodes 30 (six or more calculation nodes in the example illustrated in FIG. 1). The number of the calculation nodes 30 may be changed when necessary. The calculation nodes 30 each execute a job on the basis of an instruction provided by the management server 10a (described later). The execution instruction that is provided by the management server 10a may include information that specifies a secondary file server 60 that is used to execute the job. When the execution instruction includes the information that specifies the secondary file server 60, the calculation node 30 uses the specified secondary file server 60 to execute the job.

Using the secondary file server 60 to execute the job may mean that a program or data, which is stored in a predetermined region of the secondary file server 60, is read and used, for example. In addition, using the secondary file server 60 to execute the job may mean that data that is generated during a calculation performed for the execution of the job or at the time of termination of the calculation is read from or written in the predetermined region of the secondary file server 60, for example.

The calculation nodes 30 each have a general computer hardware configuration and include a CPU, a RAM, a ROM, a storage device, and a network device. In the present embodiment, a detailed description of the hardware configurations is omitted for convenience.

The common file server (primary file server) 20 is a server computer that stores various programs and data (that are files) that are used by the calculation nodes 30 to execute the jobs. The common file server 20 has a server function that provides the programs and the data to the calculation nodes 30 and the secondary file servers 60. The common file server 20 is connected to the calculation nodes 30 and the secondary file servers 60 through the networks.

The common file server 20 transmits, in response to a transmission request received from each of the secondary file servers 60, a file (program and data) that is necessary for execution (operation) of a job to the interested secondary file server 60, for example. The file (program and data) that is necessary for the execution of the job is hereinafter called an input file in some cases.

In addition, the common file server 20 has a function of receiving the result (calculation result) of execution of a job from each of the calculation nodes 30 and centrally managing information of the results. The information (received from each of the calculation nodes 30) on the result of the execution of the job is hereinafter called an output file in some cases.

The common file server 20 has a general computer hardware configuration and includes a CPU, a RAM, a ROM, a storage device, and a network device. In the present embodiment, a detailed description of the hardware configuration is omitted for convenience.

The secondary file servers 60 are server computers that each store a part of the files of the common file server 20. The file server system 1a includes the plurality of secondary file servers 60 (three secondary file servers in the example illustrated in FIG. 1).

The secondary file servers 60 provide files and storage regions to the calculation nodes 30. Specifically, the secondary file servers 60 transmit programs stored in the predetermined regions and data stored in the predetermined regions to the calculation nodes 30 through the network 42. The secondary file servers 60 each receive data generated during a calculation performed for execution of a job or at the time of termination of the calculation, write the received data in the predetermined region, and read the data from the predetermined region when necessary.

The secondary file servers 60 each have a general computer hardware configuration and include a CPU, a RAM, a ROM, a storage device, and a network device. In the present embodiment, a detailed description of the hardware configurations is omitted for convenience. The number of the secondary file servers 60 may be changed when necessary.

The management server 10a controls the calculation nodes 30 so that the calculation nodes 30 execute the jobs that are related to the calculation instruction received from the client computer 50 or the like. In this case, the management server 10a distributes the plurality of jobs to the calculation nodes 30 and controls the calculation nodes 30 so that the calculation nodes 30 execute the jobs.

In order to instruct any of the calculation nodes 30 to execute a job, the management server 10a selects a secondary file server 60 to be used for the execution of the job by the calculation node 30, and notifies the interested calculation node 30 of the selected secondary file server 60.

The fact that the management server 10a specifies (selects) a secondary file server 60 to be used by a calculation node 30 on the basis of an instruction for execution of a job means that the management server 10a assigns the job to the secondary file server 60 or assigns the secondary file server 60 to the calculation node 30 in some cases.

The management server 10a has a general computer hardware configuration and includes a CPU (not illustrated), a RAM (not illustrated), a ROM (not illustrated), a network device (not illustrated), and a storage device 101.

The storage device 101 is a storage device such as a hard disk drive (HDD), solid state drive (SSD) or the like. The storage device 101 stores various types of data. The storage device 101 stores a job assignment table 102.

In the present embodiment, a detailed description of the hardware configuration of the management server 10a is omitted for convenience.

Various functions (described later) of the management server 10a are achieved by causing the CPU of the management server 10a to execute a management program stored in the storage device or the like. The management server 10a instructs at least one of the calculation nodes 30 to execute a job by transmitting the following information (a) to (d), for example.

Program information (a)

Parameter information (b)

Input data information (c)

Secondary file server information (d)

The program information (a) is information on a program to be used for the execution of the job. For example, the program information (a) is the program, information specifying the program, or information of a location at which the program is stored.

For example, when the management server 10a has, stored therein, the program to be used for the execution of the job, the management server 10a transmits, to the interested calculation node 30, the program as the program information (a). In addition, when the calculation node 30 already has the program, the management server 10a transmits, to the calculation node 30, the information specifying the program as the program information (a). When the management server 10a and the calculation node 30 do not have the program, the management server 10a transmits, to the calculation node 30, information (for example, information of a location at which the program is stored in the common file server 20) of a location at which the program is stored as the program information (a).

The parameter information (b) is information such as a setting value to be used for execution of the program. The input data information (c) is information on data input for the execution of the program. When the management server 10a has the input data stored therein, the management server 10a transmits, to the interested calculation node 30, the input data as the input data information (c).

When the calculation node 30 already has the input data, the management server 10a transmits, to the calculation node 30, information specifying the input data as the input data information (c).

When the management server 10a and the calculation node 30 do not have the input data, the management server 10a transmits, to the calculation node 30, information (for example, information of a location at which the input data is stored in the common file server 20) of a location at which the input data is stored as the input data information (c).

The secondary file server information (d) is information that specifies a secondary file server 60 to be used by the calculation node 30 to execute the job. When the calculation node 30 needs to use the secondary file server 60 to execute the job, the management server 10a transmits, to the calculation node 30, information specifying the secondary file server 60 as the secondary file server information (d).

In the file server system 1a, the management server 10a has functions as a load state management unit 11, a selector 12, and an assignment management unit 13 as illustrated in FIG. 1.

The load state management unit 11 manages load states of the calculation nodes 30. In the present embodiment, the load state management unit 11 includes a job number management unit 111 as illustrated in FIG. 1.

The job number management unit 111 manages the numbers of jobs assigned to the secondary file servers 60. Specifically, the job number management unit 111 uses the job assignment table 102 to manage the numbers of the jobs assigned to the secondary file servers 60.

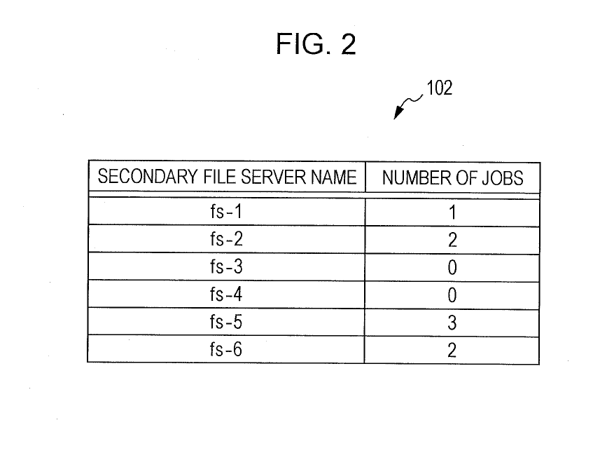

FIG. 2 is a diagram illustrating an example of the job assignment table 102 included in the file server system 1a according to the example of the first embodiment.

The job assignment table 102 includes the names (secondary file server names) of the secondary file servers 60 and the numbers of the jobs, while the secondary file server names are associated with the numbers of the jobs in the job assignment table 102.

In the example illustrated in FIG. 2, the job assignment table 102 is provided for six secondary file servers 60 with names fs-1 to fs-6. For example, three jobs are assigned to the secondary file server 60 with the name fs-5.

In the example illustrated in FIG. 2, a job is not assigned to the secondary file servers 60 with the names fs-3 and fs-4. In other words, the numbers of jobs assigned to the secondary file servers 60 with the names fs-3 and fs-4 are 0.

When a job is assigned to a secondary file server 60 or when a job assigned to a secondary file server 60 is completed, the job number management unit 111 updates the job assignment table 102.

For the assignment of the job to the secondary file server 60, the selector 12 selects a secondary file server 60 to be assigned to the calculation node 30 from among the plurality of secondary file servers 60. Specifically, the selector 12 selects, from among the plurality of secondary file servers 60, the secondary file server 60 to which the lowest load is applied.

The selector 12 references the job assignment table 102 that is managed by the job number management unit 111 of the load state management unit 11. Then, the selector 12 selects the secondary file server 60 to which the smallest number of jobs are assigned. When a plurality of secondary file servers 60 to which the smallest number of jobs are assigned exist, the selector 12 may randomly select one of those secondary file servers. In addition, when the plurality of secondary file servers 60 to which the smallest number of jobs are assigned exist, the selector 12 may prioritize a secondary file server 60 having high processing performance in accordance with a predetermined priority order, and select the single secondary file server 60 from among the secondary file servers 60.

The assignment management unit 13 assigns the job to be executed to the secondary file server 60 selected by the selector 12.

Specifically, the assignment management unit 13 transmits, to the calculation node 30 to which the job to be executed is assigned, an execution instruction that includes, as the secondary file server information, information specifying the secondary file server 60 selected by the selector 12.

The assignment management unit 13 notifies the job number management unit 111 that the assignment management unit 13 has assigned the job to the secondary file server 60. The job number management unit 111 updates the job assignment table 102 on the basis of the notification.

The management server 10a manages jobs using queues (job queues).

Next, a method for executing a job in the thus-configured file server system 1a according to the example of the first embodiment is described below.

In the management server 10a, the job number management unit 111 of the load state management unit 11 uses the job assignment table 102 and manages the number of jobs assigned to each of the secondary file servers 60 of the file server system 1a.

When the user enters the calculation instruction from the client computer 50, the management server 10a manages the jobs related to the calculation instruction.

The selector 12 references the job assignment table 102 and selects a secondary file server 60 to which the smallest number of jobs are currently assigned.

In other words, the selector 12 selects, from among the plurality of secondary file servers 60, the secondary file server 60 to which the lowest load is assigned. The assignment management unit 13 assigns the interested job to the secondary file server 60 selected by the selector 12.

In the file server system 1a according to the example of the first embodiment, since the job is assigned, on a priority basis, to the secondary file server 60 to which the lowest load is assigned, loads can be distributed to the plurality of secondary file servers 60.

Thus, it is possible to prevent jobs from being concentrated in a specific secondary file server 60 and a high load from being applied to the specific secondary file server 60. Therefore, the system can operate in a stable manner.

### (B) Second Embodiment

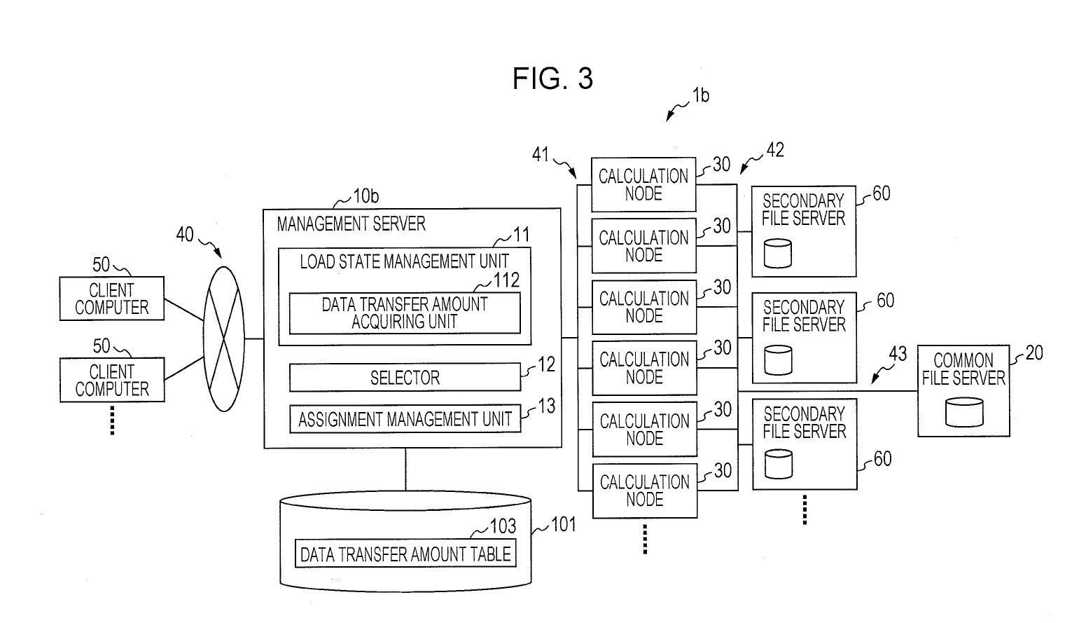

FIG. 3 is a diagram schematically illustrating the configuration of a file server system 1b according to an example of a second embodiment.

The file server system 1b according to the example of the second embodiment is a distributed processing system that distributes jobs related to a calculation instruction to the plurality of calculation nodes 30 and causes the plurality of calculation nodes 30 to execute the jobs, in the same manner as the file server system is according to the example of the first embodiment.

As illustrated in FIG. 3, the file server system 1b according to the second embodiment includes a management server 10b instead of the management server 10a according to the first embodiment. In addition, the file server system 1b according to the second embodiment includes a data transfer amount table 103 instead of the job assignment table 102.

In addition, the load state management unit 11 of the management server 10b includes a data transfer amount acquiring unit 112 instead of the job number management unit 111 according to the first embodiment. The file server system 1b has the same parts as the other parts of the file server system 1a according to the first embodiment.

In FIG. 3, reference numerals that are the same as the aforementioned reference numerals indicate parts that are the same as or substantially the same as the parts indicated by the reference numerals, and a detailed description thereof is omitted.

The data transfer amount acquiring unit 112 acquires information of the amounts of data transferred (written and read) to and from the secondary file servers 60.

For example, the data transfer amount acquiring unit 112 transmits, to each of the secondary file servers 60, a command to request the secondary file server 60 to transmit information of the amount of data transferred through the network 42. Then, the data transfer amount acquiring unit 112 acquires, from each of the secondary file servers 60, the information of the amount of the data transferred (written and read).

Since the data transfer amount acquiring unit 112 can use at least one of known various methods and acquire the information of the amount of the data (transferred (written and read)) from each of the secondary file servers 60, a detailed description thereof is omitted.

The load state management unit 11 manages, as the data transfer amount table 103 of the storage device 101, the information (acquired by the data transfer amount acquiring unit 112) of the amount of data transferred (written and read) to and from each of the secondary file servers 60.

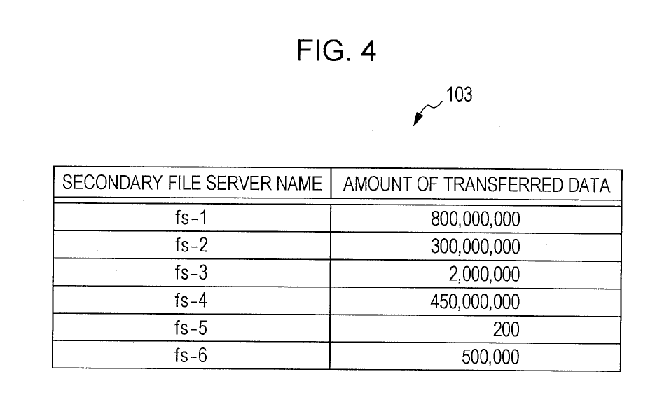

FIG. 4 is a diagram illustrating an example of the data transfer amount table 103 included in the file server system 1b according to the example of the second embodiment.

The data transfer amount table 103 includes the names (secondary file server names) of the secondary file servers 60 and the amounts of the data transferred (written and read), while the secondary file server names are associated with the amounts of the data transferred (written and read) in the data transfer amount table 103.

In the example illustrated in FIG. 4, the data transfer amount table 103 is provided for the six secondary file servers 60 with the names fs-1 to fs-6. For example, it is apparent that the amount of data transferred (written and read) to and from the secondary file server 60 with the name fs-1 is 800,000,000 bits per second (bps). From the example illustrated in FIG. 4, it is apparent that the amount of data transferred (written and read) to and from the secondary file server 60 with the name fs-5 is 200 bps and smallest.

Every time a job is assigned to at least one of the secondary file servers 60, the data transfer amount acquiring unit 112 transmits, to each of the secondary file servers 60, the command to request the secondary file server 60 to transmit the information of the amount of the transferred data, and acquires the information of the amount of the data transferred (written and read) to and from each of the secondary file servers 60. Every time the load state management unit 11 receives the information of the amount of the transferred data from any of the second file servers 60, the load state management unit 11 updates the data transfer amount table 103.

Next, a method for executing a job in the file server system 1b according to the example of the second embodiment is described below.

For example, when the user enters the calculation instruction from the client computer 50, the management server 10b manages the jobs related to the calculation instruction.

In the management server 10b, the data transfer amount acquiring unit 112 of the load state management unit 11 transmits, to each of the secondary file servers 60, the command to request the secondary file server 60 to transmit the information of the amount of the transferred data, and acquires the information of the amount of the data transferred (written and read) to and from each of the secondary file servers 60.

Every time the load state management unit 11 receives the information of the amount of the transferred (written and read) data from any of the secondary file servers 60, the load state management unit 11 updates the data transfer amount table 103.

The selector 12 references the data transfer amount table 103 and selects a secondary file server 60 to and from which the smallest amount of data is transferred (written and read). Specifically, the selector 12 selects, from among the plurality of secondary file servers 60, the secondary file server 60 to which the lowest load is applied. The assignment management unit 13 assigns the interested job to the secondary file server 60 selected by the selector 12.

In the file server system 1b according to the example of the second embodiment, since the job is assigned, on a priority basis, to the secondary file server 60 to which the lowest load is applied, loads can be distributed to the plurality of secondary file servers 60.

Thus, it is possible to prevent jobs from being concentrated in a specific secondary file server 60 and a high load from being applied to the specific secondary file server 60. Therefore, the system can operate in a stable manner. In addition, loads that are applied to the secondary file servers 60 can be equalized.

### (C) Third Embodiment

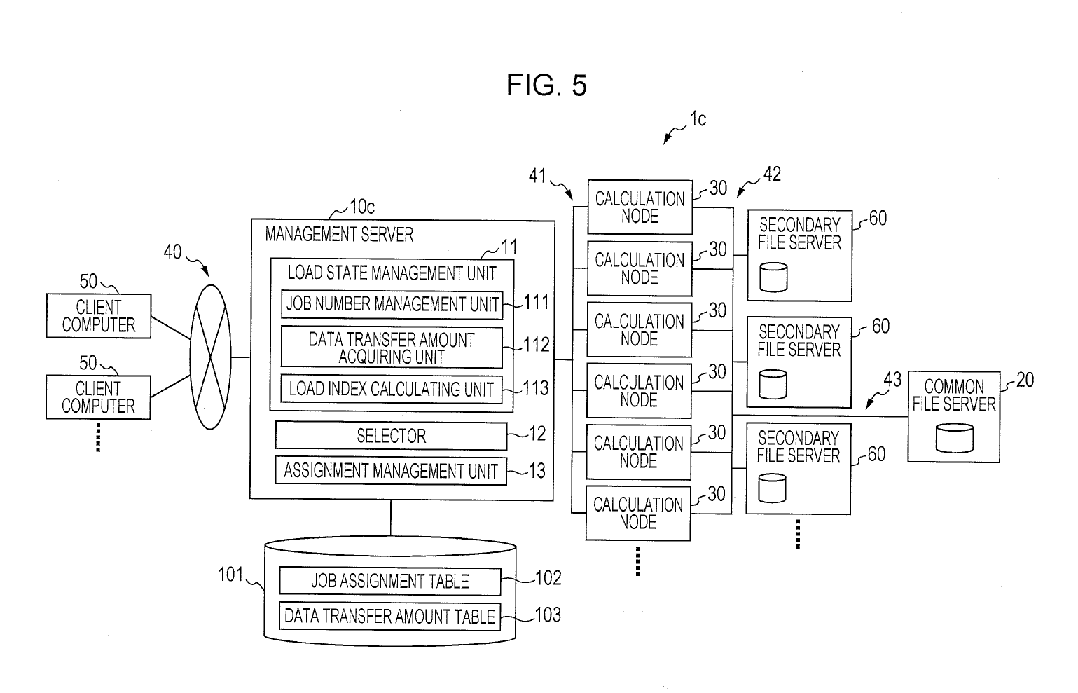

FIG. 5 is a diagram schematically illustrating the configuration of a file server system 1c according to an example of a third embodiment.

The file server system 1c is a distributed processing system that distributes jobs related to a calculation instruction to the plurality of calculation nodes 30 and causes the plurality of calculation nodes 30 to execute the jobs, in the same manner as the file server system 1a according to the first embodiment.

As illustrated in FIG. 5, the file server system 1c according to the third embodiment includes a management server 10c instead of the management server 10a according to the first embodiment. In addition, the file server system 1c according to the third embodiment has the job assignment table 102 and the data transfer amount table 103 in the storage device 101.

In addition, the load state management unit 11 of the management server 10c includes the job number management unit 111 according to the first embodiment, the data transfer amount acquiring unit 112 and a load index calculating unit 113.

Thus, in the file server system 1c according to the example of the third embodiment, the load state management unit 11 has both functions, which are the job number management unit 111 according to the first embodiment and the data transfer amount acquiring unit 112, and manages the load states of the secondary file servers 60 on the basis of the number of the jobs assigned to each of the secondary file servers 60 and the amount of the data transferred (written and read) to and from each of the secondary file servers 60.

The file server system 1c according to the example of the third embodiment has the same parts as the other parts of the file server system 1a according to the first embodiment.

In FIG. 5, reference numerals that are the same as the aforementioned reference numerals indicate parts that are the same as or substantially the same as the parts indicated by the reference numerals, and a detailed description thereof is omitted.

The load index calculating unit 113 calculates a load index for each of the plurality of secondary file servers 60 on the basis of the numbers of the jobs assigned to the secondary file servers 60 and the numbers of the data transferred to and from the secondary file servers 60. Specifically, the load index calculating unit 113 calculates a load index (LoadIndex(FSn)) for each of the secondary file servers 60 according to the following Equation (1).

LoadIndex(FSn)=a×JobNum(FSn)+b×Traffic(FSn) (1)

In Equation (1), JobNum(FSn) is the number of jobs assigned to the secondary file server 60 and can be acquired from the job assignment table 102.

In addition, Traffic(FSn) is the amount of data transferred to and from the secondary file server 60 and can be acquired from the data transfer amount table 103 or can be acquired by the data transfer amount acquiring unit 112 when the data transfer amount acquiring unit 112 transmits the command to request the secondary file server 60 to transmit the information of the amount of the transferred data.

In Equation (1), symbols a and b are load coefficients and can be set to any values by the user or an administrator. When the load coefficient a or b is set to a large value, the job can be assigned to the second file server 60 while the amount of the jobs or the amount of the transferred data is weighted.

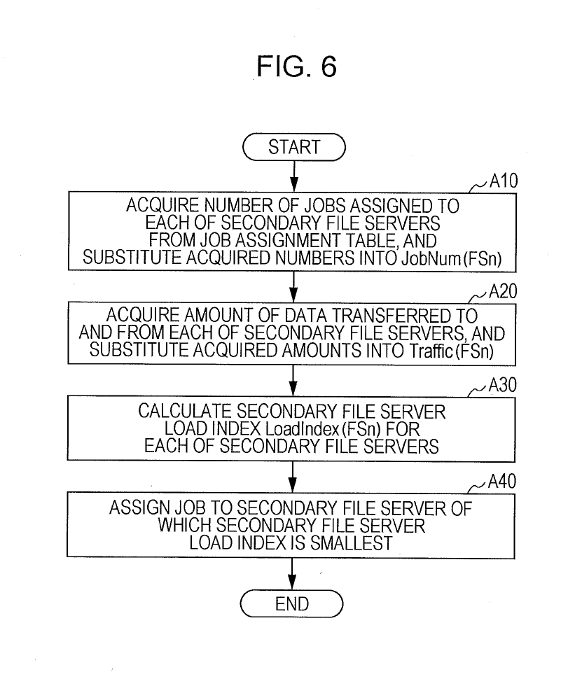

A process of assigning a job to a secondary file server 60 in the thus-configured file server system 1c according to the example of the third embodiment is described with reference to a flowchart (operations A10 to A40) illustrated in FIG. 6.

In order for the management server 10c to assign a job to any of the calculation nodes 30, the job number management unit 111 references the job assignment table 102, acquires the numbers of the jobs assigned to the secondary file servers 60, and substitutes the acquired numbers of the assigned jobs into JobNum(FSn) (in operation A10).

Next, the data transfer amount acquiring unit 112 transmits, to each of the secondary file servers 60, the command to request the secondary file server 60 to transmit the information of the amount of the transferred data, and acquires, from each of the secondary file servers 60, the information of the amount of the transferred (written and read) data. The data transfer acquiring unit 112 causes the acquired amounts of the transferred (written and read) data to be registered in the data transfer amount table 103, and substitutes the acquired amounts of the transferred (written and read) data into Traffic(FSn) (in operation A20).

Then, the load index calculating unit 113 calculates a load index (secondary file server load index) LoadIndex(FSn) for each of the secondary file servers 60 according to the aforementioned Equation (1) using JobNum(FSn) calculated in operation A10 and Traffic(FSn) calculated in operation A20 (in operation A30).

The selector 12 selects a secondary file server 60 of which the load index is smallest on the basis of the load indexes (of the secondary file servers 60) calculated in operation A30. The assignment management unit 13 assigns the job to the secondary file server 60 selected by the selector 12 (in operation A40).

In this manner, the file server system 1c according to the example of the third embodiment obtains an effect that is the same as or similar to the first and second embodiments. In addition, since the load coefficients a and b are changed and set when necessary, the job can be applied to the secondary file server 60 while the number of the jobs or the amount of the transferred (written and read) data is weighted.

### (D) First Modified Example

In each of the file server systems 1a, 1b, and 1c according to the first to third embodiments, a load of the common file server 20 is not necessarily reduced when the secondary file server 60 is used in order for the calculation node 30 to execute the job.

When the calculation node 30 uses the secondary file server 60 to execute the job, it is necessary to transfer the last input and output files between the common file server 20 and the secondary file server 60 before and after the job. In this case, the last input and output files are not work files.

Thus, when the number of times of reading and writing operations that are performed by the calculation node 30 to read and write a file from and in the external is small during the execution of the job, the transfer of the input and output files before and after the job may cause a load to be applied to the common file server 20.

When the number of times of the reading and writing operations that are performed by the calculation node 30 to read and write a file from and in the external is small during the execution of the job, and the calculation node 30 executes the job directly using the common file server 20, it is not necessary to transfer the input and output files between the common file server 20 and the secondary file server 60 before and after the job. As a result, the load of the common file server 20 and a load of the network can be reduced.

When the calculation node 30 accesses a file located in the external in order to execute the job and the number of times of access from the calculation node 30 to the file located in the external is small, the calculation node 30 does not use the secondary file server 60. This can reduce the load of the common file server 20 and improve an efficiency of the entire system.

Thus, in each of the first to third embodiment, it is preferable that the file server system have a determining unit (not illustrated) that determines whether or not the secondary file server 60 needs to be used. In addition, in each of the third to third embodiment, it is preferable that when the determining unit determines that the secondary file server 60 needs to be used, the secondary file server 60 be used.

In a first modified example, the determining unit (not illustrated) determines whether or not the secondary file server 60 needs to be used when the management server 10a, 10b, and 10c assigns the job to the calculation node 30.

In the following description, any of the management servers 10a, 10b, and 10c is indicated by reference numeral 10.

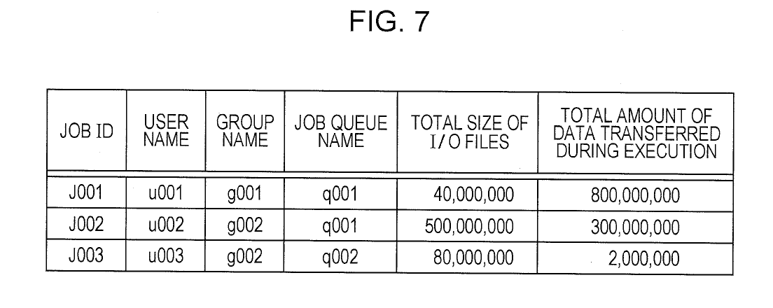

Specifically, in the first modified embodiment, the determining unit determines, on the basis of a job transfer amount recording table (data transfer records) illustrated in FIG. 7, whether or not the secondary file server 60 needs to be used.

FIG. 7 is a diagram illustrating an example of the job transfer amount recording table that is used in the first modified example. In the job transfer amount recording table, information that is acquired by execution of jobs by the calculation node 30 is recorded. The job transfer amount table has a job ID column, a user name column, a group name column, a job queue name column, an input/output file size column, and a column for the amount of data transferred (written and read) during the execution.

In the job transfer amount recording table, each of job IDs is information (identification information) that identifies the interested job. The management server 10 arbitrarily sets the job IDs. Each of user names is information that identifies a user that enters a calculation instruction for an interested job. Each of group names is information that identifies a group (user group) to which a user belongs. Each of job queue names is information that identifies a queue in which an interested job is registered in the management server 10. The user names, the group names and the job queue names are attribute information pieces on the jobs.

Each of the sizes of input/output files is the total data size of input and output files, each of which has been transmitted or received by the common file server 20 before or after execution of an interested job.

Each of the amounts of data transferred (written and read) during execution is the amount of data transferred (written and read) to and from the calculation node 30 during execution of an interested job.

In the job transfer amount recording table, the aforementioned information is sequentially recorded for each of the jobs.

Every time execution of a new job starts, the determining unit references the job transfer amount recording table on the basis of a user name corresponding to the job to be executed and calculates trends of data transfer related to the same user name.

Specifically, the determining unit extracts, from the job transfer amount recording table, data entries corresponding to the same user name and calculates, from the extracted data entries, the total of the sizes of input and output files, and the total of the amounts of data transferred (written and read) during the execution.

The aforementioned totals may be calculated from all the data entries extracted from the job transfer amount recording table. In addition, the totals may be calculated from a predetermined number (for example, 10 data entries) of data entries among all the data entries extracted from the job transfer amount recording table.

In order to calculate, from the predetermined number of data entries, the total of the sizes of the input and output files and the total of the amounts of the data transferred (written and read) during the execution, it is preferable that data entries for recently executed jobs be prioritized and used.

The determining unit calculates a determination reference value CompareIndexOfUser using the following Equation (2).

CompareIndexOfUser=(The total of the sizes of the input and output files for jobs with the same user name)−(The total of the amounts of the data (for the jobs with the same user name) transferred (written and read) during the execution) (2)

When the calculated value CompareIndexOfUser is larger than 0, the determining unit determines that the second file server 60 does not need to be used. When the calculated value CompareIndexOfUser is equal to or smaller than 0, the determining unit determines that the second file server 60 needs to be used.

Specifically, during the execution of the job, the determining unit checks, as the trends of the data transfer for the job, the magnitude relationship between the total amount of the files transferred (written and read) during the execution of the job by the calculation node 30 and the total amount of input and output files transferred for assignment of the job. As a result, when the total amount of the input and output files transferred for the assignment of the job is larger than the total amount of the files transferred (written and read) during the execution of the job by the calculation node 30, the determining unit determines that the secondary file server 60 does not need to be used.

When the total amount of the input and output files transferred for the assignment of the job is equal to or smaller than the total amount of the files transferred (written and read) during the execution of the job by the calculation node 30, the determining unit determines that the secondary file server 60 needs to be used.

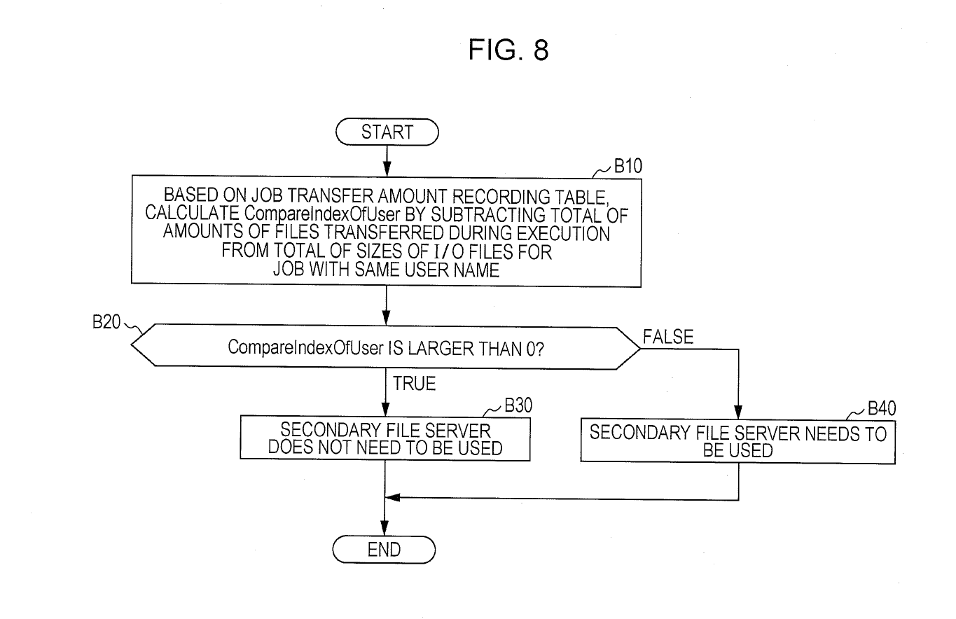

A method for determining whether or not the secondary file server 60 needs to be used in the thus-configured file server system according to the first modified example is described with reference to a flowchart (operations B10 to B40) illustrated in FIG. 8.

When the management server 10 assigns the job to the calculation node 30, the determining unit references the job transfer amount recording table and extracts a predetermined number of data entries corresponding to the same user ID as the user name corresponding to the job to be executed. Then, the determining unit calculates, from the extracted data entries, the total of the sizes of the input and output files, and the total of the amounts of files transferred (written and read) during the execution of the job, and calculates the value CompareIndexOfUser using the aforementioned Equation (2) (in operation B10).

Then, the determining unit determines whether or not the calculated value CompareIndexOfUser is larger than 0 (in operation B20). When the calculated value CompareIndexOfUser is equal to or smaller than 0 (False in operation B20), the determining unit determines that the secondary file server 60 needs to be used (in operation B40).

When the determining unit determines that the secondary file server 60 needs to be used, the assignment management unit 13 transmits, to the calculation node 30, an execution instruction that includes the program information (a), the parameter (b), the input data information (c), and the secondary file server information (d).

On the other hand, when the calculated value CompareIndexOfUser is larger than 0 (True in operation B20), the determining unit determines that the secondary file server 60 does not need to be used (in operation B30).

When the determining unit determines that the secondary file server 60 does not need to be used, the assignment management unit 13 transmits, to the calculation node 30, an execution instruction that includes the program information (a), the parameter (b) and the input data information (c).

Since the assignment management unit 13 does not cause the instruction (to be provided to the calculation node 30 for the execution of the job) to include the secondary file server information (d), the assignment management unit 13 prevents the secondary file server 60 from being used by the calculation node 30.

The file server system according to the first modified example obtains the same effect as the file server system 1a, 1b or 1c according to the first, second or third embodiment and can obtain another effect described below.

When the total amount of the input and output files transferred for the assignment of the job is larger than the total amount of the files transferred (written and read) during the execution of the job by the calculation node 30, the determining unit determines, on the basis of the trends of the data transfer for the job, that the secondary file server 60 does not need to be used.

Thus, it is possible to prevent files from being inefficiently transferred for use of the secondary file server 60 and thereby prevent unnecessary traffic from being transferred in the network 42. Therefore, the system can operate in an efficient manner.

### (E) Second Modified Example

In the first modified example, every time execution of a new job starts, the determining unit references the job transfer amount recording table on the basis of the user name corresponding to the job to be executed and calculates the trends of data transfer related to the same user name. However, the calculation is not limited to this.

The determining unit may reference the job transfer amount recording table on the basis of the group name and the job queue name in the job transfer amount recording table and calculate the trends of data transfer related to the same group name and the job queue name.

In a second modified example, the determining unit calculates the trends of data transfer on the basis of the user name, the group name, and the job queue name and determines, on the basis of information obtained by the calculations, whether or not the secondary file server 60 needs to be used. The second modified example describes a method for determining whether or not the secondary file server 60 needs to be used.

In the second modified example, the determining unit extracts data entries corresponding to the same user name from the job transfer amount recording table and calculates, from the extracted data entries, the total of the sizes of input and output files, and the total of the amounts of files transferred (written and read) during the execution of the job.

Specifically, the determining unit calculates a determination reference value CompareIndexOfUser using the following Equation (3).

CompareIndexOfUser={(The total of the sizes of input and output files for jobs with the same user name)−(The total of the amounts of files (for the jobs with the same user name) transferred (written and read) during the execution of the job)}/(The number of the jobs with the same user name) (3)

In addition, the determining unit extracts data entries corresponding to the same group name from the job transfer amount recording table and calculates, from the extracted data entries, the total of the sizes of input and output files, and the total of the amounts of files transferred (written and read) during the execution of the job.

Specifically, the determining unit calculates a determination reference value CompareIndexOfGroup using the following Equation (4).

CompareIndexOfGroup={(The total of the sizes of the input and output files for jobs with the same group name)−(The total of the amounts of the files (for the jobs with the same group name) transferred (written and read) during the execution of the job)}/(The number of the jobs with the same group name) (4).

In addition, the determining unit extracts data entries corresponding to the same job queue name from the job transfer amount recording table and calculates, from the extracted data entries, the total of the sizes of input and output files, and the total of the amounts of files transferred (written and read) during the execution of the job.

Specifically, the determining unit calculates a determination reference value CompareIndexOfQueue using the following Equation (5).

CompareIndexOfQueue={(The total of the sizes of the input and output files for jobs with the same job queue name)−(The total of the amounts of the files (for the jobs with the same job queue name) transferred (written and read) during the execution of the job)}/(The number of the jobs with the same job queue name) (5).

The reason that the division is performed using the number of the jobs in each of Equations (3) to (5) is that since the number of the jobs with the same user name, the number of the jobs with the same group name and the number of the jobs with the same job queue name are not necessarily equal to each other, the average value is used in each of Equations (3) to (5).

In order to calculate each of the determination reference values, the totals may be calculated from all the data entries extracted from the job transfer amount recording table. In addition, in order to calculate each of the determination reference values, the totals may be calculated from a predetermined number (for example, 10 data entries) of data entries among all the data entries extracted from the job transfer amount recording table.

In order to calculate, from the predetermined number of the data entries, the total of the sizes of input and output files, and the total of the amounts of files transferred (written and read) during the execution of the job, it is preferable that data entries that correspond to recently executed jobs be prioritized and used.

Then, the determining unit calculates a comparison reference value A using the following Equation (6) on the basis of the calculated determination reference values CompareIndexOfUser, CompareIndexOfGroup, and CompareIndexOfQueue.

Comparison reference value A=c×CompareIndexOfUser+d×CompareIndexOfGroup+e×CompareIndexOfQueue (6)

Symbols c, d and e are load coefficients and can be set to any values by the user or the administrator. When the load coefficient c, d, and e is set to a large value, the determining unit can determine whether or not the secondary file server 60 needs to be used while weighting the user name, the group name or the job queue name.

When the calculated comparison reference value A is larger than 0, the determining unit determines that the secondary file server 60 does not need to be used. When the calculated comparison reference value A is equal to or smaller than 0, the determining unit determines that the secondary file server 60 needs to be used.

Specifically, the determining unit calculates, as the trends of data transfer related to the job during the execution of the job, the determination reference values CompareIndexOfUser, CompareIndexOfGroup, and CompareIndexOfQueue on the basis of the total amount of files transferred (written and read) during the execution of the job by the calculation node 30 and the total amount of input and output files transferred for the assignment of the job for each of the same user name, the same group name, and the same job queue name.

The determining unit calculates the comparison reference value A on the basis of the determination reference values CompareIndexOfUser, CompareIndexOfGroup, and CompareIndexOfQueue. The determining unit determines whether the calculated comparison reference value A is larger than 0, and whereby the determining unit determines whether or not the secondary file server 60 needs to be used.

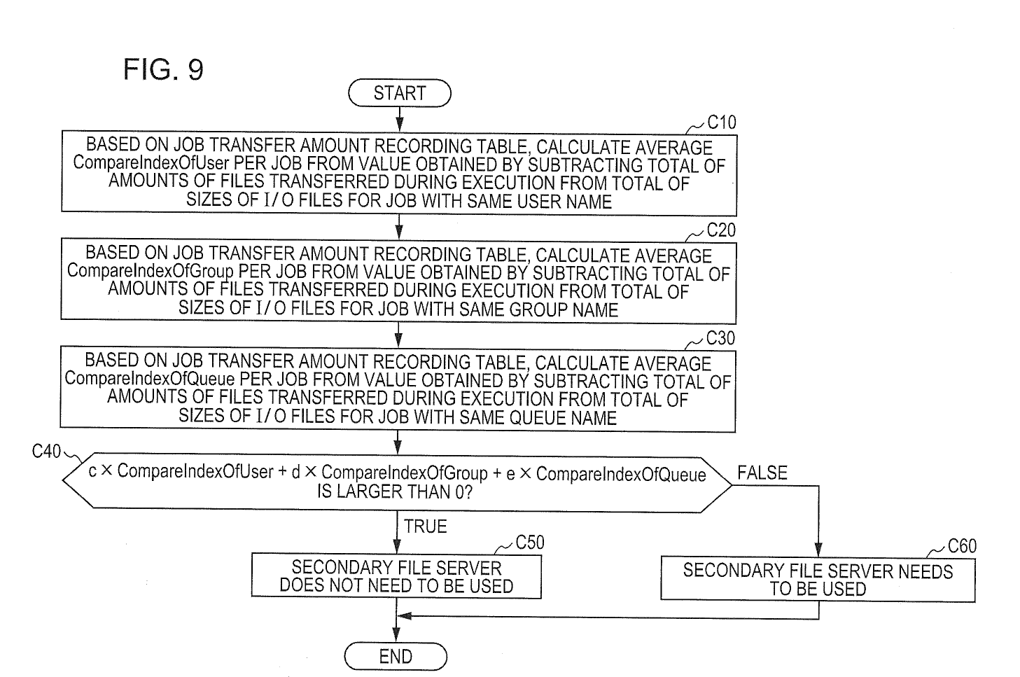

A method for determining whether or not the secondary file server 60 needs to be used in the file server system according to the second modified example is described with reference to a flowchart (operations C10 to C60) illustrated in FIG. 9.

The determining unit references the job transfer amount recording table, subtracts the total of the amounts of the files transferred (written and read) during the execution of the job from the total of the sizes of the input and output files for the jobs with the same user name, and calculates the average CompareIndexOfUser by dividing the value obtained by the subtraction by the number of the jobs with the same user name (in operation C10).

In addition, the determining unit references the job transfer amount recording table, subtracts the total of the amounts of the files transferred (written and read) during the execution of the job from the total of the sizes of the input and output files for the jobs with the same group name, and calculates the average CompareIndexOfGroup by dividing the value obtained by the subtraction by the number of the jobs with the same group name (in operation C20).

In addition, the determining unit references the job transfer amount recording table, subtracts the total of the amounts of the files transferred (written and read) during the execution of the job from the total of the sizes of the input and output files for the jobs with the same job queue name, and calculates the average CompareIndexOfQueue by dividing the value obtained by the subtraction by the number of the jobs with the same job queue name (in operation C30).

The order of operations C10 to C30 is not limited to this, and any of operations C10 to C30 may be first performed.

After that, the determining unit calculates the comparison reference value A from the results obtained in operations C10 to C30 and determines whether the calculated comparison reference value A is larger than 0 (in operation C40).

When the calculated comparison reference value A is equal to or smaller than 0 (False in operation C40), the determining unit determines that the secondary file server 60 needs to be used (in operation C60). When the calculated comparison reference value A is larger than 0 (True in operation C40), the determining unit determines that the secondary file server 60 does not need to be used (in operation C50).

In this manner, the file server system according to the second modified example can obtain an effect that is the same as or similar to the aforementioned first modified example. In addition, the file server system according to the second modified example can determine whether or not the secondary file server 60 needs to be used, on the basis of the trends (of data transfer) calculated on the basis of the three types of the information that is the user name, the group name, and the job queue name. Thus, the file server system according to the second modified example can make the determination that is suitable for an actual operation. Therefore, the reliability of the file server system can be improved.

In the present modified example, the trends of data transfer are not necessarily calculated on the basis of the three types of the information that is the user name, the group name and the job queue name. The information to be used to calculate the trends can be changed when necessary. For example, when any of the user name, the group name, and the job queue name is not used to calculate the trends of data transfer, the interested load coefficient c, d, and e are set to 0.

### (F) Third Modified Example

In the second modified example, the load coefficients c, d, and e that are used to calculate the comparison reference value A can be set to any values by the user or the administrator. However, the setting of the load coefficients c, d, and e is not limited to this. The load coefficients c, d, and e may be automatically determined on the basis of the actual results of the job.

Specifically, in a third modified example, the load coefficients c, d and e are calculated using the following Equations (7) to (9).

Load coefficient c=σ (CompareIndexOfGroup)×σ (CompareIndexOfQueue) (7)

Load coefficient d=σ (CompareIndexOfUser)×σ (CompareIndexOfQueue) (8)

Load coefficient e=σ (CompareIndexOfUser)×σ (CompareIndexOfGroup) (9)

Where σ ( ) represents a standard deviation. For example, σ (CompareIndexOfGroup) represents a standard deviation of the determination reference value CompareIndexOfGroup.

By calculating the load coefficients c, d, and e using the standard deviations of the determination reference values, weights that are based on the standard deviations are set for the data transfer trends calculated for each of the attribute information pieces. Thus, the determining unit has a function as a weight setting unit that sets the weights (based on the standard deviations) for the data transfer trends calculated for each of the attribute information pieces.

Thus, the variations (standard deviations) of the determination reference values can be reflected in the load coefficients c, d, and e. Feedback control can be achieved on the basis of the actual results of the job.

### (G) Others

The techniques disclosed herein are not limited to the embodiments and the modified example, and may be modified without departing from the gist of the techniques disclosed herein.

For example, when a specific job that causes a file to be frequently accessed exists, a dedicated secondary file server (specific secondary file server) that executes the specific job is provided, and the management unit 13 does not assign a job other than the specific job to the specific secondary file server. Therefore, the specific job that causes the file to be frequently accessed can be efficiently executed.

In this case, it is preferable that a specific job queue that is provided for the job for which the specific secondary file server is used be provided and the specific secondary file server be used only for the job held in the specific job queue.

In addition, the number of specific secondary file servers may be dynamically changed on the basis of the number of jobs that are held in the specific job queue for a past certain time period. Thus, the number of secondary file servers 60 that are not used can be reduced. The secondary file servers 60 can efficiently operate.

The functions that serve as the load state management unit 11, the job number management unit 111, the data transfer amount acquiring unit 112, the load index calculating unit 113, the selector 12, the assignment management unit 13, and the determining unit are achieved by causing the CPUs of the management servers 10a, 10b, and 10c to execute the management program.

The program (management program) that is executed to achieve the functions as the load state management unit 11, the job number management unit 111, the data transfer amount acquiring unit 112, the load index calculating unit 113, the selector 12, the assignment management unit 13 and the determining unit is stored in a computer-readable storage medium such as a flexible disk, a CD (CD-ROM, CD-R, CD-RW or the like), a DVD (DVD-ROM, DVD-RAM, DVD-R, DVD+R, DVD-RW, DVD+RW, HD DVD or the like), a Blu-ray disc, a magnetic disk, an optical disc, or a magneto-optical disc. A computer reads the program from the storage medium, and transfers the read program to an inner storage device or an external storage device so that the program is stored in the inner storage device or the external storage device.

In addition, the program may be stored in the storage device such as the magnetic disk, the optical disc, the magneto-optical disc or the like and provided to the computer through a communication path.

The program that is stored in the inner storage device (RAMs or ROMs of the management servers 10a, 10b and 10c in the embodiments) is executed by a microprocessor (CPU in the embodiments) of the computer so that the functions that serve as the load state management unit 11, the job number management unit 111, the data transfer amount acquiring unit 112, the load index calculating unit 113, the selector 12, the assignment management unit 13 and the determining unit are achieved. The program that is stored in the storage medium may be read and executed by the computer.

In the embodiments, the computers each include an operating system and hardware that operates under control of the operating system. When the operating system is not necessary and the hardware is operated only by an application program, the hardware itself corresponds to the computer.

The hardware includes a microprocessor (such as the CPU) and a unit that reads the computer program stored in the storage medium. In the embodiments, the management servers 10a, 10b and 10c each have a function as the computer.

In the embodiments and the modified examples, the functions of the management server 10 may be achieved by a plurality of server computers. The functions of the management server 10 may be modified and achieved when necessary.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A file server system comprising:
a plurality of calculation nodes configured to execute jobs by using files;
a primary file server configured to store the files related to the jobs;
a plurality of secondary file servers configured to store a part of the files of the primary file server;
a load state management unit configured to manage load states of the secondary file servers;
a selector configured to select a secondary file server that is in a state of the lowest load among the secondary file servers, when the jobs to be executed are assigned; and
an assignment management unit configured to assign the jobs to be executed to the secondary file server selected by the selecting unit.

2. The file server system according to claim 1, wherein the load state management unit includes a job number management unit configured to manage the number of jobs assigned to the secondary file servers,
wherein the selector selects, from among the secondary file servers, the secondary file server to which the smallest number of jobs are assigned.

3. The file server system according to claim 1, wherein the load state management unit includes a data transfer amount acquiring unit configured to acquire the amounts of data transferred to and from the secondary file servers,
wherein the selector selects, from among the secondary file servers, a secondary file server to and from which the smallest amount of data is transferred.

4. The file server system according to claim 1, wherein the load state management unit includes a job number management unit configured to manage the numbers of jobs assigned to the secondary file servers, a data transfer amount acquiring unit configured to acquire the amounts of data transferred to and from the secondary file servers, and a load index calculating unit configured to calculate a load index for each of the secondary file servers on the basis of the numbers of the assigned jobs and the amounts of the transferred data, and
wherein the selector selects, from among the secondary file servers, a secondary file server of which the load index is smallest.

5. The file server system according to claim 1, further comprising:
a determining unit configured to determine, when the jobs to be executed are assigned, whether or not the secondary file server needs to be used, the determination being made on the basis of trends of data transfer related to the jobs during the execution of the jobs,
wherein when the determining unit determines that the secondary file server needs to be used, the selector selects the secondary file server, and the assignment management unit assigns the jobs to be executed to the secondary file server selected by the selector.

6. The file server system according to claim 5,
wherein the determining unit acquires data transfer trends for each of a plurality of types of attribute information pieces on the jobs, and determines, on the basis of the data transfer trends acquired for each of the attribute information pieces, whether or not the secondary file server needs to be used.

7. The file server system according to claim 6, further comprising
a weight setting unit configured to set a weight based on a standard deviation to the data transfer trends acquired for each of the attribute information pieces.

8. A method for executing a job in a file server system that includes a plurality of calculation nodes configured to execute jobs by using files, a primary file server configured to store the files related to the jobs, and a plurality of secondary file servers configured to store a part of the files of the primary file server, the method comprising:
managing load states of the secondary file servers;
selecting, from among the plurality of secondary file servers, a secondary file server to which the lowest load is applied, when the jobs to be executed are assigned; and
assigning the jobs to be executed to the secondary file server selected in the selecting.

9. The execution method according to claim 8,
wherein the load states to be managed includes the number of jobs assigned to the secondary file servers, and
wherein in the selecting, a secondary file server to which the smallest number of jobs are assigned is selected from among the secondary file servers.

10. The execution method according to 8,
wherein the load states to be managed includes the amounts of data transferred to and from the secondary file servers, and
wherein in the selecting, a secondary file server to and from which the smallest amount of data is transferred is selected from among the secondary file servers.

11. The execution method according to 8, further comprising:
managing the number of jobs assigned to the secondary file servers;
acquiring the amounts of data transferred to and from the secondary file servers; and
calculating a load index for each of the secondary file servers on the basis of the number of the assigned jobs and the amounts of the transferred data,
wherein in the selecting, a secondary file server of which the load index is smallest is selected from among the secondary file servers.

12. The execution method according to claim 8, further comprising
determining, when the jobs to be executed are assigned, whether or not the secondary file server needs to be used, the determination being made on the basis of trends of data transfer related to the jobs during the execution of the jobs,
wherein when it is determined that the secondary file server needs to be used in the determining, the secondary file server is selected in the selecting, and the jobs to be executed are assigned to the file server selected in the selecting in the assigning.

13. The execution method according to claim 12,
wherein in the determining, data transfer trends are acquired for each of a plurality of types of attribute information pieces on the jobs, and whether or not the secondary file server needs to be used is determined on the basis of the data transfer trends acquired for each of several types of attribute information.

14. The execution method according to claim 13, further comprising
setting a weight based on a standard deviation to the data transfer trends acquired for each of the several types of attribute information.

15. A management device that manages jobs in a file server system, the management device comprising:
a plurality of calculation nodes configured to execute the jobs by using files;
a primary file server configured to store the files related to the jobs;
a plurality of secondary file servers configured to store a part of the files of the primary file server;
a load state management unit configured to manage load states of the secondary file servers;
a selector configured to select, from among the secondary file servers, a secondary file server to which the lowest load is applied, when the jobs to be executed are assigned; and
an assignment management unit configured to assign the jobs to be executed to the secondary file server selected by the selector.

16. The management device according to claim 15,
wherein the load state management unit includes a job number management unit configured to manage the number of the jobs assigned to the secondary file servers, and
wherein the selector selects, from among the secondary file servers, a secondary file server to which the smallest number of the jobs are assigned.

17. The management device according to claim 15,
wherein the load state management unit includes a data transfer amount acquiring unit configured to acquire the amounts of data transferred to and from the secondary file servers, and
wherein the selector selects, from among the secondary file servers, a secondary file server to and from which the smallest amount of data is transferred.

18. The management device according to claim 15,
wherein the load state management unit includes a job number management unit configured to manage the numbers of the jobs assigned to the secondary file servers, a data transfer amount acquiring unit configured to acquire the amounts of data transferred to and from the secondary file servers; and a load index calculating unit configured to calculate a load index for each of the secondary file servers on the basis of the number of the assigned jobs and the amounts of the transferred data, and
wherein the selector selects, from among the secondary file servers, a secondary file server of which the load index is smallest.

19. The management device according to claim 15, further comprising
a determining unit configured to determine, when the jobs to be executed are assigned, whether or not the secondary file server needs to be used, the determination being made on the basis of trends of data transfer that is related to the jobs during the execution of the job,
wherein when the determining unit determines that the secondary file server needs to be used, the selector selects the secondary file server and the assignment management unit assigns the jobs to be executed to the secondary file server selected by the selector.

20. A computer-readable, non-transitory medium storing a program causing a computer to execute a process, the computer managing jobs in a file server system that includes a plurality of calculation nodes configured to execute jobs by using files, a primary file server configured to store the files related to the jobs, and a plurality of secondary file servers configured to store a part of the files of the primary file server, the process comprising:
managing load states of the secondary file servers;
selecting, from among the plurality of secondary file servers, a secondary file server to which the lowest load is applied, when the jobs to be executed are assigned; and
an assigning the jobs to be executed to the secondary file server selected by the selecting.
